(19) United States
(12) Patent Application Publication
(10) Pub. No.: US 2009/0132276 A1
(43) Pub. Date: May 21, 2009

(54) METHODS AND SYSTEMS FOR CLINICAL DOCUMENTS MANAGEMENT BY VOCAL INTERACTION

(76) Inventor: Michael G. Petera, Casper, WY (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/270,199

(22) Filed: Nov. 13, 2008

Related U.S. Application Data
(60) Provisional application No. 60/987,655, filed on Nov. 13, 2007.

(51) Int. Cl. G06Q 50/00; G06F 17/20

(52) U.S. Cl. 705/2; 715/273

(57) ABSTRACT

This invention relates to methods and systems for medical document management of emergency medical and health care facilities. A system may comprise a portable voice prompted/activated input/output unit, a patient encounter transaction support facility, a clinical documents database, and an application development environment. The system may comprise methods, by a wireless clinical environment, for capturing and managing clinical documents using the voice command and response unit that operates in conjunction with the patient encounter transaction support facility, clinical documents database, and/or application development environment.

### CROSS REFERENCE TO RELATED APPLICATIONS

This application claims the benefit of U.S. Provisional Patent Application Ser. No. 60/987,655 entitled “Clinical Documents Management System Using Voice” filed Nov. 13, 2007, and herein incorporated by reference.

### FIELD OF THE INVENTION

This invention relates to medical documents management in the field of medicine and health care treatment facilities. More specifically, the invention may comprise methods and systems for capturing clinical documents using vocal commands and responses within a supporting patient encounter transaction support facility system and clinical documents database.

### BACKGROUND

Today's hospitals face operating environments with ever increasing challenges: rising costs, nursing shortages, increased liability exposure, reduced levels of reimbursement, and a growing Medicare population. Additionally, the majority of hospitals are also currently experiencing a capacity crunch and a need exists to increase efficiency by better managing patient flow, improving scheduling, and optimizing bed usage. Efficiencies also need to increase to meet projected surges in demand as the population ages and life expectancies increase.

Several internal departments contribute to hospitals' financial performance and measure of efficiency, with the Emergency Department (the “ED”) playing a pivotal role as a significant point of patient entry. ED visits result in a significant portion of overall inpatient admissions and, in turn, serve as a significant source of income for hospitals. The interdependence between inpatient and the ED elevates the importance of resource management, and thus, the efficiency within the ED comprises a critical component of a hospitals' overall efficiency measure that ultimately determines a hospitals' profitability and economic viability.

EDs generally provide the first line of response to life threatening injuries and illnesses, but EDs also provide a significant amount of unscheduled urgent care. EDs further serve as referral sites for other providers to evaluate and stabilize patients and provide admission to patients if necessary. EDs have reported being under increasing pressure to provide care for more patients, which regularly results in overcrowding. There are several indicators of an EDs' overcrowding. Indicators include the number of hours that EDs are on ambulance diversion, the proportion of patients and length of time that patients “board” in EDs, and the proportion of patients who leave EDs before receiving a medical evaluation, usually because they tire of waiting. Another key indicator contributing to overcrowding is the inability to move patients out of the EDs and into inpatient beds.

EDs are intimately linked to other departments of a hospital, and EDs' performance is often unintentionally affected by decisions made in these other departments, such as medical/surgical wards, ICUs, radiology, the OR, and/or the laboratory. In one example, a decision to close a nursing unit due to a staffing shortage may result in the delay of EDs' ability to move patients to a hospital bed, which results in not only unnecessarily occupying beds in EDs, but also straining nurse resources within EDs. In another example, continued acceptance of ICU transfers when there are no available ICU beds means that critically ill patients may also be housed in EDs, again effectively shrinking EDs' ability to care for the constant stream of patients arriving at its door. In yet another example, decisions made by primary care providers or specialists that negatively affect patient access to their services has repeatedly been shown to increase ED visits, thus further straining EDs' services.

Among typical EDs, care begins with a “heads-tip” and then moving the patient through arrival, triage, nursing and physician assessment, orders, results, procedures, ongoing assessments, and finally admit/transfer/discharge planning. Patient assessment must be rapid and accurate to help prevent a bottleneck. Triage, performed by a nurse, traditionally includes completing a lengthy triage nursing assessment form. In the face of EDs' overcrowding, this comprehensive triage approach is problematic. During times of EDs' overcrowding, the triage nurse is in the most crucial position for managing the burden, as the input flow continues without regard for the state of an ED. Consequently, EDs' waiting rooms become congested and triage nurses responsibilities increases tremendously. Many EDs have sped tip the process by using bedside registration and a brief triage process, but that system works only as long as beds are available. More personnel may be added to triage as soon as a certain number of people are pending triage, or if patients are waiting more than thirty minutes, but if another nurse is not available, a paramedic or a nurse practitioner is usually added to help with triage. With triage being the main bottleneck, patient data is usually collected later in the process.

In EDs, by nature, large volumes of information are collected, interpreted, and acted upon. The patient encounter may include a number of segments and phases: a history taking segment, a physical examination segment, a decision making segment, which includes a differential diagnosis phase, a diagnostic studies phase, a definitive diagnosis phase and a treatment plan phase, a documentation segment, which includes creating a record of the findings, decisions and recommendations of the patient encounter, and a communication segment that includes sharing the documentation created during the patient encounter including reports, instructions, and requests. Medical record documentation may also be initiated to record pertinent facts, findings, and observations about an individual's condition, health status, health history, past and present illnesses, examinations, tests, treatments, and outcomes.

Present systems and methods for capturing clinical documents produced during patient encounters require medical personnel to fill forms, record charts, and make dictations. Such clinical documentation capture can be problematic. For example, the dictation may take as much as five minutes or more per patient encounter, so that a typical half day clinical session may require at least one hundred minutes of dictation by the physician. This dictation is done either between patient encounters, if there is time available, or at the end of the entire clinical session. Often, the dictation must be done at the end of a physician's working day, which is sometimes well beyond normal working hours. Emergency physicians and nurses may spend an estimated hour of paperwork, including searching for charts, for every hour of providing direct patient care. Other problems can be attributed to handwritten physician and nursing notes that are regularly incomplete and sometimes inadequate for appropriate charge capture. Template documents, or even dictated notes, are often not entered timely into an electronic medical record to allow rapid retrieval and database query. Furthermore, hand written or verbal orders can contribute to medical errors in an already high-risk setting. Similarly, nurses may routinely spend a significant portion of their workday documenting patient care.

Perceptions by nurses are that much of the documentation work is redundant, and most of all, the documentation takes away from their ability to administer direct patient care. Therefore, documentation has become a significant issue for practicing nurses. Nurses working in most healthcare settings have identified the excessive burden of documentation as a source of dissatisfaction in their practice. A recent trend in nursing practice is the introduction of electronic documentation.

Although not widely implemented, clinical information systems are currently being used to enhance the productivity of the healthcare team. Many of these applications were designed to support the efficient patient care workflow of nurses and other members or the healthcare team, at the point-of-care or wherever the clinician needs to enter or access patient information. A growing number of hospitals have deployed these applications using point-of-care devices, including stationary bedside terminals, wireless laptops mounted on mobile carts, and handheld devices. Available features include an integrated clinical desktop that provides: quick and easy access to patient records, “virtual libraries” and knowledge bases, access to enterprise e-mail, and access to the Internet and a facility's intranet. Using this desktop, clinicians are able to enter necessary data into the patient's record, including orders, care plans, and notes. They may also view: individual patient results and summaries that provide an overview of the current patient status combining diagnostic results, the Medication Administration Record (MAR), nursing documentation, and current orders on one screen.

Unfortunately, the aforementioned clinical systems and processes are subject to inefficiencies that hinder adoption by hospital facilities, especially within EDs. Clinical information systems employ the use of terminal or portable computing devices that require mostly manual input of data that is usually performed in a venue removed from timely patient care. The use of point-of-care devices, including stationary bedside terminals, wireless laptops mounted on mobile carts, and handheld devices is an attempt to alleviate this problem. But, in a dynamic environment of EDs, it is often not ideal to type patient data into a computing device while administering care which requires free hands as well as full mental acuity on the task at hand such as a triage problem or the like.

Work to be done is constantly changing in EDs. For instance, a critically ill patient can have the effect of immediate re-prioritizing of all workflow in an ED. In EDs, shifting of priorities is the norm, not the exception. Despite the increasing ease of use of portable computing devices, the current data input process is also still prone to error, not necessarily convenient, and generally inefficient. For example, a data entry might be a typing error or a misinterpretation thus allowing incorrect data to be entered into the clinical information system. The current solutions are labor and time intensive, which also may lead to medical errors that may ultimately compromise patient safety. The rapid pace and acute nature of emergency care increases the likelihood that these inefficiencies will arise, hinder productivity, and negatively impact quality of care. Therefore, there is a need for an alternative system and method that addresses these and other shortcomings of the conventional medical documentation systems.

### SUMMARY OF THE INVENTION

The present invention relates to the mobile management of clinical documentation and more specifically to systems and methods for generating and processing clinical documents using voice activation. A system may comprise a portable device and a method for acquiring voice commands and processing response data to enable the capture and management of clinical information obtained during patient encounters, more specifically within the clinical environment of an emergency department. The portable device may operate in conjunction with a patient encounter transaction support facility (“PETSF”) and at least one clinical documents database via a telecommunication network, e.g., a local area network (“LAN”). The telecommunication network may be accessible to an emergency department information system (“EDIS”) and vice versa, and/or any other electronic medical record keeping system within a healthcare facility. The portable device may comprise either one or both of hardware and software (i.e. machine readable data) for performing tasks including: voice command activation, voice data acquisition, data processing, data storing, data retrieval, forms generation, document printing, audio output, wireless telecommunication, integration with electronic medical records, and the like. The patient encounter transaction support facility may be a computing server comprising either one or both of hardware and software for performing tasks including facilitating interactions relating to voice data acquisition (e.g. data input/output) between the portable device and the clinical documents database. The clinical documents database may comprise either one or both of hardware and software for performing database functions. The clinical documents database may be a standalone computing server, or as a software application functioning within the patient encounter transaction support facility. As an integral part of the system, the present invention may also comprise an application development environment comprising either one or both of hardware and software to enable development of applications relating to the conversion of clinical documents, such as conventional paper standard forms, into machine readable data representative of voice data acquired by the portable device and vice versa. The systems of the present invention may enable medical personnel to manage clinical documents during a patient encounter in an accurate, timely, and convenient manner as well as to enhance the efficiency of clinical workflow using information derived from the clinical data acquisition events within a clinical environment.

In an embodiment of the present invention, a portable device that is wireless may enable the remote management of clinical information relating to patient encounters. The portable device may comprise either one or both of hardware and software (i.e. machine readable data) to enable interactive functions including audio queries, voice menu navigation, voice-input reception, voice-input processing, voice-data conversion to machine readable data, database queries, database processing, documents generation, wired or wireless communication, audio output, and the like.

The portable device may be a hand-held or a wearable device. The portable device may operate in conjunction with an audio input/output unit capable with either one or both of a wireless and wired communication with the portable device. The portable device may be battery operated and rechargeable. In an exemplary embodiment, the portable device may be configured with a voice navigation menu that enables a user to vocally interact and select functions presented by the device. The device may be further configured to receive vocal input from a user so that when a vocal input is in the form of a verbal command or response, the vocal input device converts verbal inputs to machine readable data. Thereafter, the machine readable data may be processed within the device or through the patient encounter transaction support facility in conjunction with the clinical documents database. The portable device may provide, among other advantages, a hands-free patient data entry method to allow clinicians to perform timely clinical documentation without the need for a terminal or portable computing device that requires manual input.

In accordance with an exemplary embodiment, the present invention may comprise systems and methods for generaling at least one clinical document template and/or clinical document using the application development environment, comprising one or more of: providing a user with a visual representation of at least a portion of a document via a visual display device; audibly prompting an applicant (e.g. a patient) to provide at least one element of a clinical document (i.e. clinical data field, etc.); receiving the vocal response from the applicant; converting the vocal response to corresponding textual data; providing the applicant with an updated visual representation via the visual display device; optionally generating a printed document corresponding to the visual representation of the document; storing at least a portion of the document, storing the document as a clinical document template; storing the document as a modified clinical document template; and the like. Each clinical document template may be generated using one or more recorded prompts, one or more vocal responses, one or more grammar rules, one or more dictation rules, and combinations thereof. The clinical document template may comprise clinical data fields or information relating to patient arrival, triage, nurse or physicians assessment, test orders, test results, procedures, on-going assessments, planning decisions such as admit, transfer, discharge, diagnoses, free-form dictations, comments, time stamps, electronic user identification, financial data, reimbursement data, and the like. The template documents may be stored in the form of machine readable data within the clinical documents database, the patient encounter transaction support facility, and/or the portable device. The clinical document templates may be retrievable from the clinical documents database using the portable device and/or from the patient encounter transaction support facility. The clinical document templates may also be accessible within the EDIS or any other medical record keeping system.

In accordance with an exemplary embodiment, the present invention may comprise systems and methods for generating, storing, retrieving, and updating clinical data fields of a clinical document template using voice commands and capture. In an embodiment, one or more clinical document templates relating to patient arrival, triage, nurse or physicians assessment, orders, results, procedures, on-going assessments, planning decisions such as admit, transfer, discharge, and the like may be converted using the application development environment. The one or more converted clinical document templates may be stored within a database as machine readable data representing the clinical document templates, for example, within the database of the patient encounter transaction support facility, and in another example, within the clinical documents database. In an alternative embodiment the clinical document templates may be stored and accessible within the wireless portable device.

In an embodiment, one or more clinical data fields may be vocally inserted or modified within a clinical document template, for example, by using the portable device, the one or more clinical data fields may be presented to a user as an audio output, via a visual display device of a patient encounter transaction support facility, and/or in printed form. For each insertion or modification of a clinical data field, one or more corresponding time stamp, and or at least one corresponding electronic identifier (i.e. signature) of a user may be recorded for review, verification, or quality assurance. In addition, at least one clinical data field of a clinical document template may be accessible to a patient encounter transaction support facility and/or an EDIS.

In accordance with an exemplary embodiment, the portable device of the present invention may comprise systems and methods for: prompting (e.g. question, statement, phrase, etc.) a user to vocally respond with one or more data fields for a clinical document template; receiving a vocal response providing one or more data fields for a clinical document template; converting the vocal response to corresponding machine readable data; providing the user with an updated audio representation of at least one clinical data fields from a clinical document template; verification of the vocal response; and/or generating a printed document corresponding to the audible representation of the document with at least one clinical data field from a clinical document inserted within the clinical document template. The one or more clinical data fields may include, but not be limited to, an individual's health status, health history, past and present illnesses, examinations, test orders, test results, treatments, outcomes, free form dictations, comments, chief complaints, allergies, medications, diagnoses, time stamp, signature, waiver, attestation, and the like.

In another exemplary embodiment of the present invention, the portable device may comprise machine readable instructions for acquiring and processing one or more voice commands and responses containing at least one clinical information element relating to patient tracking, administrative functions, clinical workflow, tasks, orders, clinical documentation, clinical decision support, and the like. The machine readable instruction may enable a user to manage documentations relating to tasks beginning with a patient's arrival, triage, nurse or physicians assessment, orders, results, procedures, on-going assessments, and planning decisions such as admit, transfer, discharge and the like. The machine readable instructions may comprise acquiring and processing voice commands and providing voice prompts to enable the capture and input of one or more clinical data fields relating to a patient's health and physical status, history, past and present illnesses, examinations, test results, treatments, outcomes, comments, chief complaints, free form dictations, and the like. The portable device may execute machine readable instructions in conjunction with the patient encounter transaction support facility and/or the clinical documents database to perform voice command and response acquisition and processing tasks. The patient encounter transaction support facility also may comprise machine readable instruction to perform distributed computing and communication functions with the portable device, clinical documents database, an EDIS, and/or or any other medical record documentation system within a healthcare facility system.

In yet another exemplary embodiment of the present invention, the patient encounter transaction support facility may comprise hardware and machine readable instructions for processing one or more clinical documents containing voice inserted clinical data fields, and storing within one or more database, for example, a clinical documents database, each database accessible to an EDIS, and/or any other medical record documentation system within a healthcare facility system. The clinical documents may be generated by one or more clinicians using one or more portable devices during one or more intermittent or simultaneous encounters with a specific patient. A clinical document and/or one or more clinical data fields within a document may be identified and analyzed manually and/or using automated logic for specific content which may include items of clinical significance. In this regard, the clinical document and/or its clinical data fields generated during a task relating to a patient's arrival, triage, nurse or physicians assessment, test orders, test results, procedures, on-going assessments, planning decisions such as admit, transfer, discharge, comments, free form dictations, and the like, may be further processed by combining, concatenating, modifying, deleting, augmenting, and the like, and combinations thereof such clinical document and/or its clinical data fields. One or more resultant clinical documents, which may be a combination of clinical inputs from several clinicians, may be generated and stored within a portable device, a patient encounter transaction support facility, a clinical documents database, and/or a stand-alone computing device. In an embodiment, a computing device, which may be part of the patient encounter transaction support facility, comprising the machine readable instructions and/or logic, that is communicable with one or more said portable devices and accessible to an EDIS or any other medical record documentation system within a healthcare facility system, may be used to facilitate the process of modifying, storing, and providing access to one or more clinical documents.

In yet another exemplary embodiment of the present invention, the patient encounter transaction support facility may comprise hardware and machine readable instructions for processing one or more clinical documents comprising voice inserted clinical data fields, which may be stored within one or more databases, for example, a the clinical documents database. In an embodiment, each database may be accessible to the EDIS or any other medical record documentation system within a healthcare facility system. A clinical document and/or one or more clinical data fields within a document may be identified and analyzed manually and/or using automated logic for specific content, which may include items of clinical significance. In this regard, the clinical document and or its clinical data fields generated during a patient encounter or task may be further processed comprising extraction of one or more specific contents. The one or more specific contents may be compiled and made accessible through a visual, graphical, audio, and/or print format to medical care personnel. The one or more specific contents may comprise personnel location, personnel assignments, alerts, critical values, patient location within the clinical facility, patient's time of arrival, medical equipment utilization, patient triage categorization (i.e. level of severity, etc.), need for quarantine, and the like. The one or more specific content may be analyzed manually and/or using automated logic, for example, in real-time to enable the efficient management of clinical workflow, facility resources, personnel utilization, triage patient prioritization, safety assurance, benchmarks, and quality measures throughout the process of patient arrival, patient tracking, registration, triage, treatment, clinical documentation, admit/discharge/transfer (“ADT”), planning, post-disposition, over all patient care, the like, and combinations thereof.

Other features and advantages of the present invention will become apparent upon examination of the following figures and detailed description. It is intended that all such features and advantages be included herein within the scope of the present invention, as defined in the appended claims.

### BRIEF DESCRIPTION OF THE DRAWINGS

The objects and features of the invention may be better understood with reference to the figures described below, and the claims. The figure drawings are not necessarily to scale, emphasis instead generally being placed upon illustrating the principles of the invention. In the figures, like numerals are used to indicate like parts throughout the various views.

While the invention is particularly shown and described herein with reference to specific examples and specific embodiments, it should be understood that various changes in form and detail may be made without departing from the spirit and scope of the invention.

FIG. 1 illustrates a block diagram of an exemplary system for clinical document a management by vocal interaction, in accordance with an exemplary embodiment of the present invention;

FIG. 2 illustrates a hardware block diagram of an exemplary device, in accordance with an exemplary embodiment of the present invention;

FIG. 3 illustrates a software block diagram of the exemplary device, in accordance with an exemplary embodiment of the present invention;

FIG. 4 illustrates a hardware block diagram of an exemplary patient encounter transaction support facility, in accordance with an exemplary embodiment of the present invention;

FIG. 5 illustrates a software block diagram of the exemplary patient encounter transaction support facility, in accordance with an exemplary embodiment of the present invention;

FIG. 6 illustrates a hardware block diagram of an exemplary clinical document management application development environment in accordance with an exemplary embodiment of the present invention;

FIG. 7 illustrates a software block diagram of the exemplary clinical document management application development environment, in accordance with an exemplary embodiment of the present invention;

FIG. 8 illustrates a plan view of an exemplary device in accordance with an exemplary embodiment of the present invention;

FIG. 9 illustrates exemplary application/circuitry elements of the device, in accordance with an exemplary embodiment of the invention; and

FIG. 10 illustrates an interconnection between the device, the patient encounter transaction support facility, and a voice recognition system, in accordance with an exemplary embodiment of the invention.

### DESCRIPTION OF EXEMPLARY EMBODIMENTS

In the following detailed description, references are made to illustrative embodiments of methods and systems for carrying out the invention. It is contemplated that devices, methods, systems, apparatuses, and processes of the claimed invention encompass variations and adaptations developed using information from the embodiments described herein. Adaptation and/or modification of the devices, methods, systems, apparatuses, and processes described herein may be performed by those of ordinary skill in the relevant art. It is understood that other embodiments may be used without departing from the scope of the invention

Throughout the description, where devices, systems, and apparatuses are described as having, including, enables, or comprising specific components, or where processes and methods are described as having, including, enabling, or comprising specific steps, it is contemplated that, additionally, there are devices, systems, and apparatuses of the present invention that consist essentially of, or consist of, the recited components, and that there are processes and methods according to the present invention that consist essentially of, or consist of, the recited processing steps. It should be understood that the order of steps or order for performing certain actions is immaterial so long as the invention remains operable. Moreover, two or mole steps or actions may be conducted simultaneously.

The mention of any publication, statements, for example, in the Background section, is not an admission that the publication or statements serves as prior art with respect to any of the claims presented herein. The Background section is presented for purposes of clarity and is not meant as a description of prior art with respect to any claim.

The present invention may be described herein in terms of functional block components and processing steps. Such functional blocks may be realized by any number of hardware or software components configured to perform the specified functions. For example, a system according to various embodiments of the present invention may be implemented in conjunction with any number of conventional computer system environments, e.g., a standalone personal computer, a plurality of personal computers linked together in a local area network (wired or wireless), a plurality of personal computers connected by a communication line such as a phone line, personal computing devices, personal digital assistance, computing tablets, and the like. Furthermore, the present invention is not limited to the process flows described herein, as any system, process flow, or rearrangement of process steps which captures one or more of the features of the present invention is within the scope of the present invention. Any number of techniques for processing steps, such as standard techniques for providing speech and/or voice recognition and the like, may be employed. The particular implementations and processes shown and described are illustrative of the present invention and are not intended to otherwise limit the scope of the present invention in any way. Indeed, for the sake of brevity, conventional voice recognition, wireless communication, database storage and retrieval, database functions distributed computing, and other well-known techniques may not be described in detail herein.

An exemplary system according to various embodiments of the present invention may be configured to provide the capability for remote storage and retrieval, via voice or other audio signal, of information used to complete various types of clinical documents associated with the clinical workflow and task management of an emergency department or any other medical record documentation system within a healthcare facility system, with tasks relating to patient arrival, triage, nurse or physicians assessment, orders, results, procedures, on-going assessments, planning decisions such as admit, transfer, discharge, and the like. Although the present system may be used to provide communication for the remote storage and/or retrieval of a variety of different types of data, clinical information data and the like that may be stored in a computer, various embodiments of the present invention are conveniently described below in connection with the remote access of information used to fill out clinical documents such as forms and charts that may be used by a medical and administrative personnel and the like. For example, a system in accordance with various embodiments of the present invention could be used by a nurse to access the databases of an EDIS or any other medical record documentation system within a healthcare facility system, view patient history, check on test results, insert comments, track patients, track tasks, and the like.

### General System Description

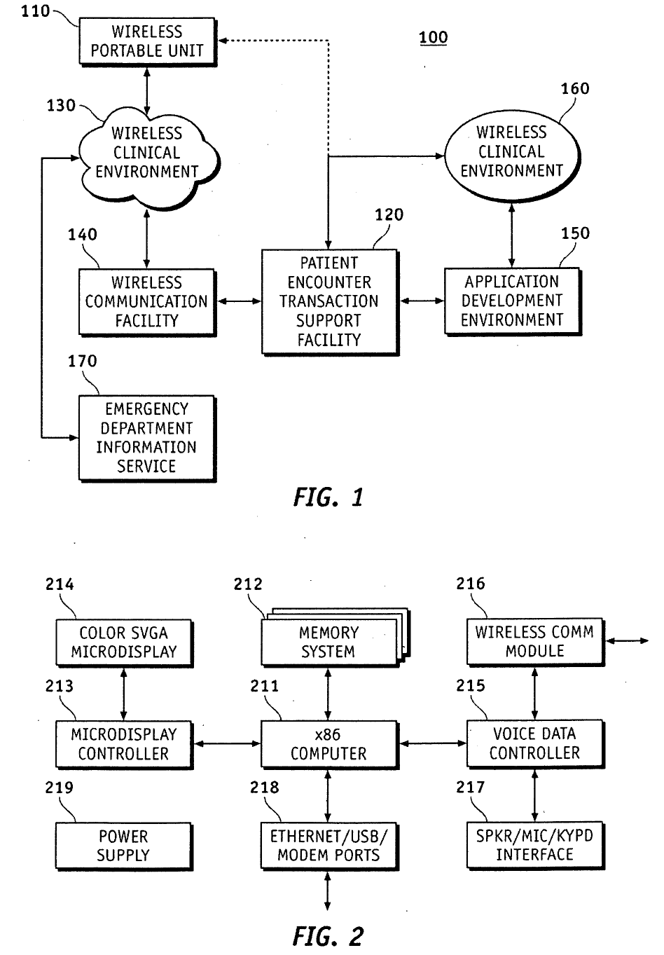

With reference to FIG. 1, a communication system 100 may comprise a wireless portable device 110, a patient encounter transaction support facility 120, a wireless clinical environment 130, a wireless communication facility 140, an application development environment 150, a clinical documents database 160, and/or an emergency department information service 170.

The communication system 100, according to various exemplary embodiments of the present invention for creating and accessing information, may comprise the remote wireless portable device 110 (“device”) that may communicate with the patient encounter transaction support facility 120. Although the device 110 may be a wireless portable device, the device 110 may comprise a variety of different configurations, for example, a device that may be connected by physical wires (e.g., conventional Ethernet cables and the like) or operate as a portable wireless device that may be located within a hospital facility. Device 110 may also reside in a vehicle, for example, an ambulance, a rescue helicopter, an emergency unit within a transport aircraft, and the like. Users of the communication system 100 may send and receive information using device 110, which may communicate with the patient encounter transaction support facility 120, by any appropriate communication technique, for example, wireless communication technologies so that the user may communicate with the patient encounter transaction support facility 120 from a remote location. Alternatively, other technologies may be used that provide for voice and data communication, for example, conventional telephone lines, dedicated communication lines, WiFi, WiMAX, Bluetooth, microwave, satellite, and the like.

The system 100 may facilitate the automation of forms-based data collection and transmission tasks necessary for conducting medical care within an emergency department setting, and the like. To achieve this automation, specialized hardware devices, speech recognition systems, and user-configurable software tools may be linked together by a wireless infrastructure, which may be an existing wireless infrastructure, for example, a local Wi-Fi network.

In operation, the device 110 may serve as the basic input/output device for a mobile system user, for example, medical personnel or medical administrators. The device 110 may be loaded with relevant clinical information from the patient encounter transaction support facility 120 via a hard-wire link, but any other manner for loading information may be used. By loading the device 110, this may allow the majority of any application specific data to be pre-loaded into the device 110 prior to mobile use. This may thereby allow for maximum utilization of the device 110 for the application with a minimum of time necessary in the wireless clinical environment 130. In an alternative embodiment, the device 110 may loaded with the relevant clinical information by an insertable and/or removable memory device comprising, for example, a compact flash memory module or removable hard disk media, etc.

In an embodiment, the mobile user may establish a communication link with the patient encounter transaction support facility 120 via the wireless clinical environment 130 and its associated wireless communication facility 140. After the wireless link has been established, the information interchange and transaction may be executed in real time. The mobile user may use voice and/or data commands comprising, but not limited to, DTMF tones, and the like, capable of synchronous or asynchronous communication with the mobile application software running on the patient encounter transaction support facility 120.

In accordance with an exemplary embodiment, the patient encounter transaction support facility 120 may serve as the focal point for all data input and output between the mobile user using the device 110 and the clinical documents database 160, as well as the other system components, for example, the application development environment 150, the emergency department information service 170, etc. In an embodiment, clinical information may be downloaded from the patient encounter transaction support facility 120 into the device 110 using conventional wire and/or wireless communication methods.

In an exemplary embodiment, upon establishment of a mobile data transaction relating to a patient encounter, the patient encounter transaction support facility 120 may record the voice-generated data input, and maintains an exact record of the data transaction. Upon completion of the data transaction, the data may be stored in the clinical documents database 160 comprising clinical documents as directed by the user using the software toolset provided within the user application development environment 150.

The user application development environment 150 may comprise custom software modules developed to interface with a variety of mobile applications, allowing a user, for example, medical personnel, to create a mobile clinical document management transaction control application for specific tasks relating to a patient encounter. The clinical documents database 160 may be used by the medical professional to access the data necessary for the creation of the clinical document templates and may be the repository of the data obtained from a patient encounter. The operational hardware and software profiles for each of the above mentioned system components are described below.

The emergency department information system (“EDIS”) 170 comprises information relevant to an emergency department, but EDIS 170 is merely one example of an information system that system 100 may comprise, and other healthcare facility departments and their associated information systems are similarly contemplated by the present invention. Other departments may include, but are not limited to: an OR department, an ICU, a neo-natal care unit, also, any other medical record documentation system within a healthcare facility system etc. Moreover, it should be appreciated that while many of the exemplary embodiments of system 100 discussed reference EDs and EDIS 170, other departments and their associated information systems may also comprise part of system 100, either in lieu of the ED/EDIS 170 or in addition to the ED/EDIS 170.

### Device 110—Hardware

In accordance with an exemplary embodiment, device 110 may comprise a computing device, or the like, for example, a hand-held device. With reference to FIG. 2, a hardware block diagram of the device 110 is shown.

In an exemplary embodiment, the device 110 may comprise an x86-based computer 211, although any processor system type may be employed, and a memory system 212 that may comprise a minimum of 128 MB of RAM, a minimum of 512 MB of non-volatile memory, for example, a compact flash memory module, or removable hard disk media, and a minimum of 4 MB of ROM storage for a Linux Operating System, but not limited to any particular operating system, and other Linux programs or other operating programs may be used.

The device 110 may also comprise micro-display controller 213 that utilizes circuitry to efficiently integrate a color super video graphics array (SVGA) micro-display 214 (although any micro-display device may be employed) into the hardware/software environment. The color SVGA micro-display 214 and its associated optics may create a near-to-the-eye, virtual display image equivalent to the screen of a laptop computer, featuring full-color SVGA (e.g., 800×600 pixel) resolution. The device 110 may also comprise any other type of display device or display device technology, in any resolution to provide visual feedback to a user.

The device 110 may also comprise a voice/data controller 215 to separate the interactive data and the voice information from the incoming communication stream that may be received via a wireless communications module 216, and send the incoming data to the x86-based computer 211 and the voice information to the speaker/micro-phone/keypad controller assembly 217. In an exemplary embodiment, a speaker-independent voice navigation menu may be implemented in lieu of keypad functions. In this case, the controller assembly 217 may be configured with limited key-pad functions. The wireless communication module 216 may, in one example, incorporate Bluetooth technology hardware/software. The device 110 may further comprise Ethernet, universal serial bus (USB), and/or modem ports 218 to serve as the wired communications to the x86-based computer 211. The device 110 may also comprise a power supply module 219 to provide the field power for the hand-held nodule. The power supply module 219 may be battery-operated and/or rechargeable.

### Device 110—Software

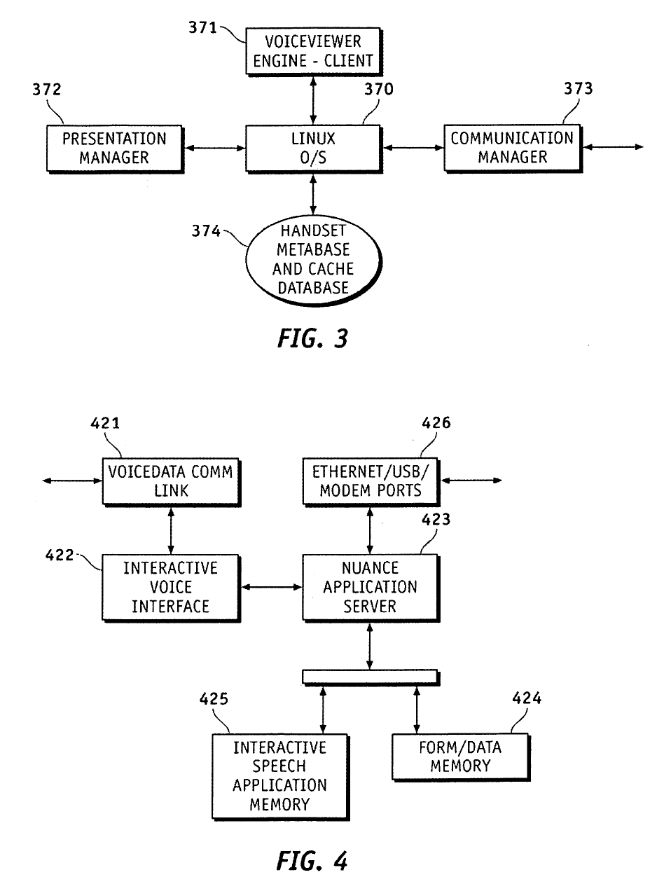

In accordance with an exemplary embodiment of the present invention, the software features of the device 110 are shown in FIG. 3. In an embodiment, the device 110 may comprise a Linux Operating System (“OS”) 370 and the Linux OS 370 may control the operation of the device 110. Although the Linux OS 370 may be used in actual practice, any number of other operating systems may be used, based upon preference, and/or the architecture of the processor in computer 211. A full-featured version of the Linux OS 370 may comprise the complete set of software tools necessary for proper operation of the x86 processor in the X-Windows environment. In an embodiment, the kernel may be specifically modified to manage the micro-display interface. The open-source nature of the Linux OS may also allow the device 110 to be easily configured for specific customer applications.

In an embodiment, VoiceViewer Engine 370 may comprise software, operating in the client mode, to control the transfer of information between the device 110 and the patient encounter transaction support facility 120.

In accordance with an exemplary embodiment, user display information may be sent to the color SVGA micro-display module 214 by the presentation manager 372. The presentation manager 372 may comprise software that may control the update of the micro-display 214 via an x86 PCI bus or as required by the display bus interface. The communication manager 373 may comprise software that maintains the current status of the interactive data flow and supervises the data transfer to the portable Metabase and cache database 374. The portable Metabase and cache database 374 may provide memory space for the user interactive forms and for the list of valid field inputs for presentation on the micro-display 214. The cache memory 374 may hold the working copy of any form data currently being updated. In an embodiment, the presentation manager 372 may operate in conjunction with the Linux OS 370 to provide a speaker-independent voice navigation menu for the device 110.

### The Wireless Environment 130

In accordance with an exemplary embodiment, the wireless clinical environment 130 may comprise conventional technology that comprises, but is not limited to, standards such as cellular advanced mobile phone service (AMPS), code division multiple access (CDMA), global system for mobile communications (GSM), the 802.11 local area network standard, instrumentation, scientific, medical (ISM) standards, and the like. In alternative embodiments, Bluetooth and “n”-G systems or any other communication systems designed to transmit data may be incorporated within wireless clinical environment 130.

### The Wireless Communication Facility 140

In an exemplary embodiment, the wireless communication facility 140 may be the commercial facility that provides the communication infrastructure in the region or within an environment in which the system 100 may be deployed for services. Various telecommunication companies (e.g., Verizon, AT&T) exist that may comprise the resources to connect the mobile user to the patient encounter support facility 120. In addition, communication infrastructure comprising localized wireless networks may be employed comprising, but not limited to, WiFi, WiMAX, infrared, and the like.

### The Transaction Support Facility 120—Hardware

In accordance with an exemplary embodiment of the present invention, the server-based patient encounter transaction support facility 120 may allow the seamless interface of data between the database application and the mobile medical personnel. With reference to FIG. 4 a hardware diagram of an exemplary patient encounter transaction support facility 120 is shown. The hardware features of the patient encounter support facility 120 may comprise a voice/data communication is link 421 which may separate the incoming transmissions initiated from the user environment and may dedicate each transmission to a separate interactive voice interface 422. The interactive voice interface 422 may route the incoming voice stream into an application server, such as the Nuance™ application server 423. The Nuance™ application server 423 may then convert the incoming voice stream into the digital commands and data necessary for the execution of an application. Commercially available speech and voice recognition hardware and/or software may be used, such as voice recognition and software technology available from Nuance™ communications, but other commercial or privately developed voice/speech recognition programs and/or suppliers may also be used.

In an embodiment, an interactive form/data application memory 424, used by the application server 423, may comprise the clinical document forms or templates and required clinical data field inputs for comparison with the data that is provided by the mobile user. This memory 424 may also comprise the information generated by the Metabase within the device 110 and may cache the interactive response data from the mobile user. An interactive speech application memory 425 may store the customer-generated voice commands for proper control and management of the user input from the mobile environment.

In an embodiment, ports 426 from the application server 423, including, but not exclusive to, the Ethernet, universal serial bus and telephone modem, may be used for downloading customer-generated forms and data into the device 110.

### The Transaction Support Facility 120—Software

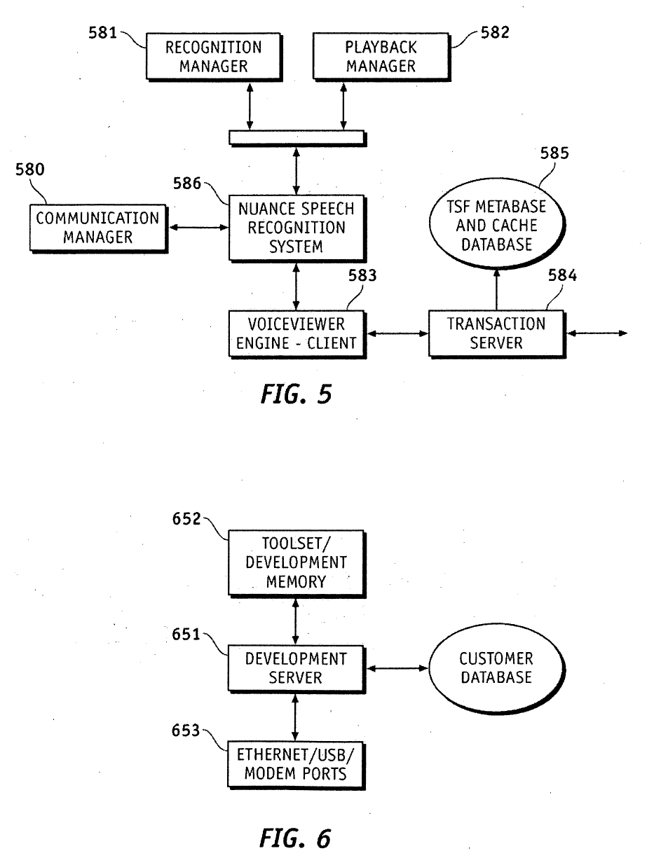

In accordance with an exemplary embodiment, the software used in the patient encounter transaction support facility 120 may control the interface of data between the clinical document database application 160 and a mobile medical personnel user using the device 110. With reference to FIG. 5 the software block diagram of the patient encounter transaction support facility 120 is shown. The software features of the patient encounter transaction support facility 120 may comprise a communication manager 580, a recognition manager 581, a playback manager 582, a VoiceViewer engine 583, a transaction server 584, and Metabase and cache database 585. Communication manager 580 may comprise software that interfaces with the device 110 to a separate voice/data communications channel within speech recognition system 586. Recognition manager 581 may comprise software that provides the interface between the voice-generated data presented from the mobile user and the customer-generated software application. Playback manager 582 may comprise software that provides the command interface from the customer-generated software to the mobile user. The playback manager 582 software-interface may comprise the actual voice commands used to solicit information from the mobile user. The VoiceViewer engine 583 may comprise software, operating in the server mode to interact with information passed between the patient encounter transaction support facility 120 and the device 110. This software module may supervise the update of the interactive mobile data and may handle the data transfer between the mobile user and the cache database 585.

Transaction server 584 may comprise software that may handle the download of the data contained within the cache memory 585 into the clinical documents database 160. This server, through commands generated in the application development environment 150, may control the timing and protocol of the data transmitted to the clinical documents database 160. Metabase and cache database 585 may comprise the form-based information generated by the interaction between the device 110 environment and the clinical documents database 160.

### The Application Development Environment 150—Hardware

In accordance with an exemplary embodiment and with reference to FIG. 6, the hardware used within an exemplary embodiment of the application development environment 150 is shown. The application development environment 150 may comprise, but is not limited to, a development server 651 comprising conventional hardware and software, a toolset/development memory 652 that may comprise custom generated data for the mobile application, and ports 653 including, but not limited to, Ethernet, universal serial bus and telephone modems that may be used for downloading customer-generated forms and data into the patient encounter transaction support facility 120. Development activities, which generate data, may use the clinical documents database 160 as a storage area for each specific application.

### The Customer Application Development Environment 150—Software

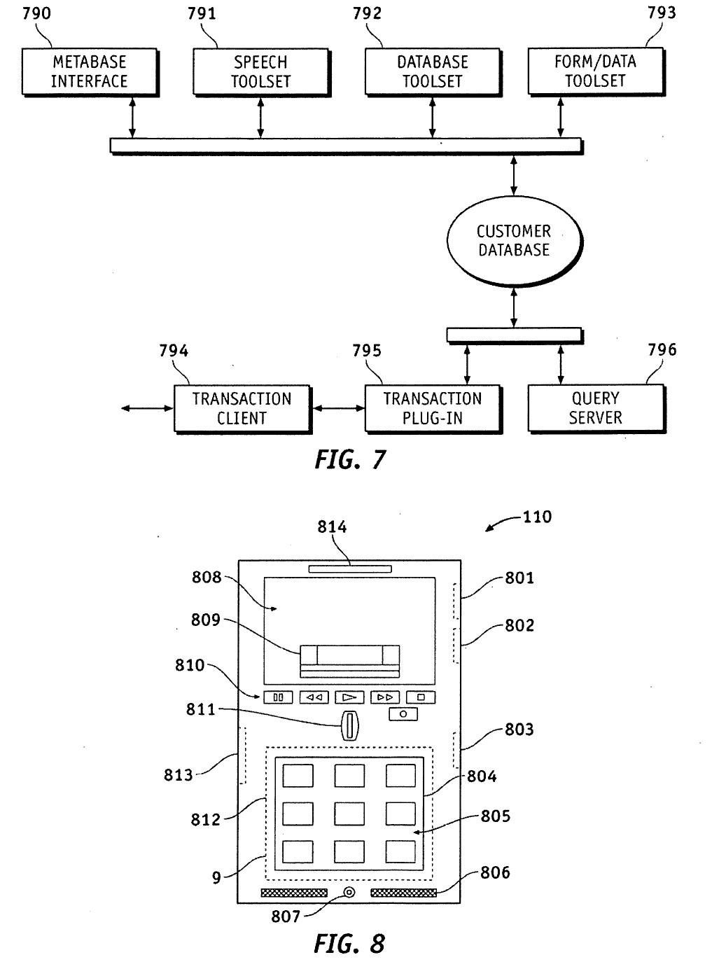

In accordance with an exemplary embodiment, the software used within the application development environment 150 may be specifically generated to enable a user to control the data gathering and reporting activities from the total mobile portable environment. With reference to FIG. 7 the software block diagram of the application development environment 150 is shown. The software features of the application development environment 150 may comprise a Metabase interface module 790, a speech toolset 791, a database toolset 792, a form/database toolset 793, transaction client 794, transaction plug-in module 795, and a query server 796.

Metabase interface module 790 may comprise software that controls the content and the timing of the clinical document forms and clinical field data that is required by the device 110. Speech toolset 791 may comprise software that allows each individual form to be created with the voice commands necessary for the user to generate the desired form input. Database toolset 792 may comprise software that allows the customer to set up the proper database information routes, and solicit and gather input data from the mobile environment and properly format the data contained within the clinical documents database 160. Form/data toolset 793 may comprise software that allows new forms to be created or existing forms to be copied that may be used by the mobile user in the device 110. Transaction client 794 may comprise software that supervises the set-up of the proper database information routes and provides for the timely update of the clinical documents database 160 from the data contained within the patient encounter transaction support facility 120. Transaction plug-in modules 795 may comprise software that allows data to be formatted and routed into “non-standard” database types in use. Query Server 796 may comprise software that polls the status of data in the metabase interface 790 that is contained within patient encounter transaction support facility 120. Query Server 796 may facilitate checking that data from the mobile user is ready for inclusion into Clinical Documents Database 160.

In an exemplary embodiment of the present invention, the application development environment 150 software (i.e. machine readable data) may be used to convert clinical documents including forms and the like into “voice-forms” or clinical document templates. The conversion may comprise: creating a list of prompts; creating a list of valid responses to each prompt; recording prompts; creating grammar rules, creating dictation rules, performing individual voice/speech and acoustical adaptation, and combinations thereof. The conversion may be performed by the user interactively using the software. For example, to create one or more applications, the software may guide a developer through the following tasks: record prompts, create “grammar” rules, create dictation rules, create a database/voice data repository, create a handset application, create a database-to-user interface, which maybe a keyboard emulator, acoustically adapt a users voice parameters, test, and/or update. Upon validation, the created clinical document templates may be stored within the clinical documents database 160. During a patient encounter, the device 110 may be used to access and retrieve one or more clinical document templates through the patient encounter transaction support facility 120.

In accordance with an exemplary embodiment and with reference to FIG. 8, an exemplary device 110 is shown. The device 110 may comprise various functional elements for accomplishing the various tasks of the present invention as described. In an embodiment, the device 110 may comprise an output connection 801, an input connection 802, a power input 803, a manual input 804, which may comprise a key pad 805, speakers 806, a microphone 807, a display 808, which may comprise a displayed exemplary clinical document 809, controls 810, a control mechanism 811, internal application/circuitry 812, a port/slot 813, and/or a device functionality component 814. This embodiment comprising the above elements is merely exemplary of one embodiment of the device 110 and the device 110 may be structurally or functionally altered from this exemplary embodiment to comprise some, all, or additional elements.

In an exemplary embodiment, the output connection 801 may be used to hardwire the device 110 to various external hardware systems (e.g. via a USB Interface). For example, the device 110 may be hardwired to the patient encounter transaction support facility 120 to down load data that has been captured by the device 110. In this exemplary embodiment, only one output connection 801 is shown, but the device 110 may comprise more than one output connection, and output connection of various types.

The device 110 may also comprise the input connection 802, and similar to the output connection 801, the input connection 802 may be likewise capable of hardwiring the device 110 to various external hardware systems. For example, the device 110 may be hardwired to the patient encounter transaction support facility 120, the application development environment 150, etc. to upload data, software, etc. In this exemplary embodiment, only one input connection 802 is shown, but the device 110 may comprise more than one input connection, and input connection of various types.

The device 110 may comprise the power input 803. The power input 803 may allow the device 110 to be hardwired directly to a power source, such as a plug outlet, to provide power to the device 1100. The power input 803 may also act as a conduit to an internal power supply of the device 110 (not shown) to charge any internal power supply. The device 110 may also comprise metal contacts (not shown) that act as a conduit to an internal power supply, and may allow the device 110 to be set in an external charging station comprising corresponding charging prongs that engage the metal contacts. With respect to power for the device 110, the device 110 may additionally or separately comprise a compartment (not shown) to house replaceable/rechargeable batteries.

The device 110 may comprise the manual input 804. The manual input 804 may allow a user to input information and/or interact with the device 110 via the keypad 805. Thus, in addition to any voice input, manual input 804 may provide an alternate mechanism to input, edit, revise, etc. data/information to the device 110.

The device 110 may comprise speaker (earphones) 806 and/or microphone 807. These elements may provide the main audible inputs and outputs of the device 110 as described.

The device 110 may comprise the display 808, which may comprise a displayed exemplary clinical document 809. The display 808 may provide the visual representation of the information to be provided to the user. The display 808 may allow the user to visually confirm the vocal input by the user and/or allow the user to follow any corresponding audio output by the device 110. The display 808 may comprise any type of display to accurately depict the visual information, for example, an LCD screen, a plasma screen, a color SVGA micro-display 214 as described earlier, etc. In one embodiment, display 808 may also act as an input mechanism. For example, the display 808 may comprise a touch screen or a pressure sensitive screen. In the touch screen embodiment, many of the controls may be displayed and/or interacted by the user directly on the screen of display 808.

The device 110 may comprise the controls 810. The controls 810 may be used by the user to manipulate the input and/or output of the device 110. For example, the controls 810 may be used to record, stop, pause, play, fast forward, rewind, etc., any of the information input to the device 110 and/or played back by the device 110.

The device 110 may also comprise the control mechanism 811. The control mechanism 811, in one embodiment, may comprise a scroll wheel. The scroll wheel 811 may be another element to allow a user to control the device 110, for example, information displayed on the display 808. The scroll wheel 811 may allow a user to move the visual information, highlight all or parts of the visual information, edit the visual information etc. In another embodiment, control mechanism 811 may not comprise a scroll wheel, but may comprise any other type of control mechanism, for example, a joy stick, etc.

The device 110 may also comprise a port/slot 813 to receive, for example, a removable memory device, for example, a SD Card and the like, to provide mobility of information stored on the removable memory device. This may allow a user to exchange information with the device 110 and other devices, such as a computer, cell phone, PDA, etc, which can similarly receive the removable member device.

The device 110 may comprise functionality component 814 to allow a complete range of additional functionality for the device 110, including but not limited to a Bar Code Scanner, a RFID device, a camera, a WiFi interface and the like. In an embodiment, functionality component 814 may comprise the Bar Code Scanner to allow a user to operate the device 110 to read bar codes associated with, for example, a patient's file for uploading of information, medical supplies to allow for proper billing, medication to track dosage and the like, healthcare areas to track patient movement, etc. In another embodiment, functionality component 814 may comprise the digital camera to capture visual images. In yet another embodiment, functionality component 814 may comprise the WiFi interface to wirelessly communicate with other communication systems. It should be appreciated that functionality component 814 is not limited to the embodiments described, but may comprise other components as well, either currently known or developed in the future.

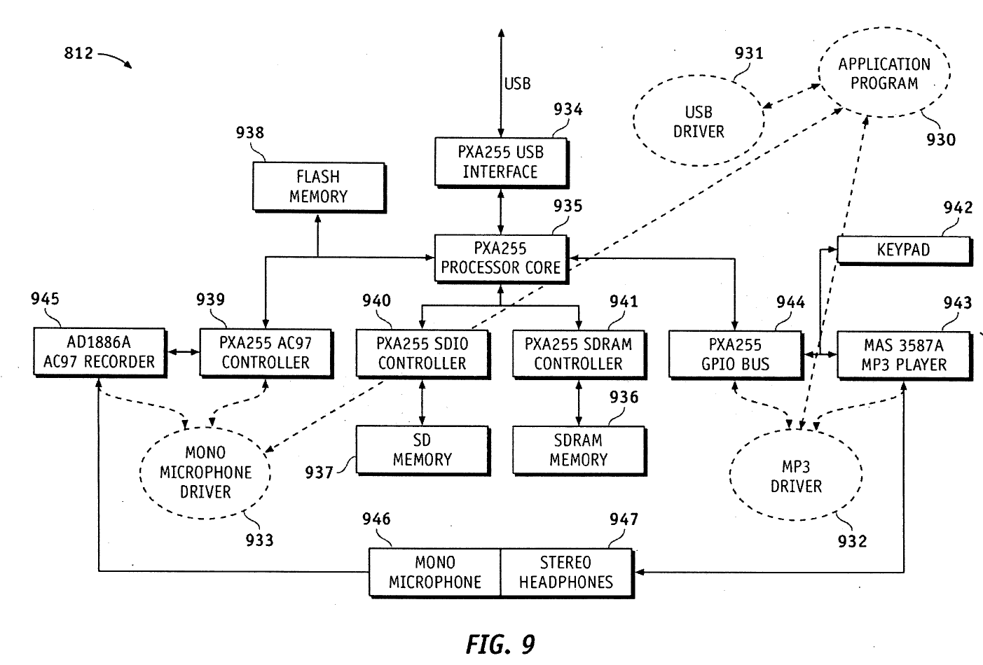

In an embodiment, the device 110 may comprise application/circuitry 812 to facilitate the function of the various elements of the device 110. In accordance with an exemplary embodiment and with reference to FIG. 9, application/circuitry elements 812 are shown that may facilitate the function of the various elements of the device 110. In an embodiment, application/circuitry elements 812 may comprise one or more of: an application program 930, a USB driver 931, an MP3 driver 932, and/or a microphone driver 933. In this embodiment, the application program 930 may comprise software to control the various drivers 931-933, and the drivers 931-933 may interact with other application/circuitry elements 812.

Application/circuitry elements 812 may also comprise one or more of: a USB interface 934 to provide USB port connection capabilities, an internal processor 935 to coordinate and/or interconnect the various application/circuitry elements 812, memory elements 936-938 to store information, controllers 939-941 to provide control information to various application/circuitry elements 812, a keypad 942 to input data, an MP3 player 943, which may be coupled to the internal processor 935 via GPIO Bus 944, and a recorder 945 to record vocal input. In one embodiment, the recorder 945 may be coupled to microphone 946 and MP3 player 943 may be coupled to headphones 947.

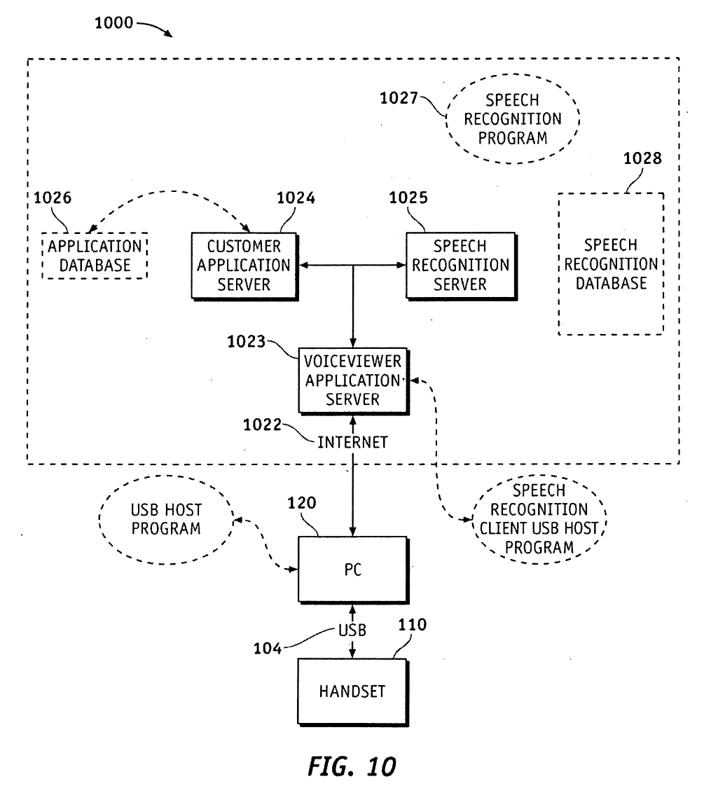

In accordance with an exemplary embodiment and with reference to FIG. 10, the device 110 may be suitably coupled to the patient encounter transaction support facility 120. The coupled elements demonstrate an exemplary manner for the device 110 to gain access to an exemplary voice recognition system 1000. In an exemplary embodiment, the device 110 may be coupled to the patient encounter transaction support facility 120 via a USB connection 1021, but other connections and/or hardwired communication mechanisms may be used. In an embodiment, the device 110 may connect through patient encounter transaction support facility 120 to the Internet 1022 to access the voice recognition system 1000, which in turn provides the device 110 access to a VoiceViewer application server 1023. In this embodiment the VoiceViewer application server 1023 may be accessed via the Internet 1022, but in other embodiments the VoiceViewer application may be supported by: a local server, internal memory of the patient encounter transaction support facility 120, and the like.

In an exemplary embodiment, the VoiceViewer application server 1023 may communicate with and/or comprise a customer application server 1024 and/or a speech recognition server 1025. Customer application server 1024 may comprise particular details for each customer accessing the VoiceViewer application 1023, and in addition, the customer application server 1024 may further comprise an application database 1026 to store particular customer data. Speech recognition server 1025 may comprise the information/software to facilitate the voice recognition for the device 110, and may also comprise a speech recognition program 1027 and/or a speech recognition database 1028. In this exemplary embodiment, voice recognition system 1000 represents merely one embodiment of a voice recognition system and other similar systems comprising different, additional, and/or altered applications may also be used and/or accessed by the device 110 and/or the patient encounter transaction support facility 120. Voice recognition system 1000 may, instead of comprising a standalone system that is externally accessed by the device 110 through the Internet 1022, also comprise a voice recognition system that may be part of either one or both of the device 110, the patient encounter transaction support facility 120, and other systems described.

### Examples of the Applications for Device 110

In accordance with an exemplary embodiment, a variety of clinical documents may be completed for a variety of functions relating to medical care during a patient encounter. These representative functions may described by a number of proceeding exemplary embodiments and serve as examples of the usefulness of the present invention, for example, the system 100 comprising the device 110, for improving the efficiency of clinical workflow and tasks managements within an ED setting. Among various embodiments, the capabilities provided by the present invention are highlighted to further demonstrate its utility. The terms “may”, “enable”, “may”, “provides”, “allows” are used to define and demonstrate the characteristics and functions of the system and methods representative of the inventiveness, scope, and spirit of the present invention.

In an exemplary embodiment, the present invention may enable the capture and management of selective unstructured health record information. Unstructured health record information may comprise information that generally may not be divided into discrete fields and not be represented as numeric, enumerated or codified data. General examples of unstructured health record information may comprise: text, word processing document, image, and/or multimedia. Specific examples may comprise: text message to physician, text links to patient photo, links letter from family, links to scanned image of insurance card, dictated report (voice recording). A number of documents may be created that are unstructured such as signed consent or DNR (do not resuscitate) forms. These forms may be captured and managed within a patient's clinical document or within a patient's record including identifying updates, or when a document may be superseded by another.

In an alternative embodiment, the present invention may enable capture and management of structured health record information. Structured health record information may be generally divided into discrete fields, and may be enumerated, numeric or codified. Examples of structured health information may comprise: patient address (non-codified, but discrete field), systolic/diastolic blood pressure (numeric), coded result observation, coded diagnosis patient risk assessment questionnaire with multiple-choice answers. Managing clinical documents may further comprise capture, retrieval, deletion, correction, amendment, and augmentation. Among some exemplary embodiments, the present invention may allow clinical documents to be augmented by a user providing additional information regarding the healthcare data, which may not be pail of the data itself, e.g. linking patient consents or authorizations to the clinical documents of a patient.

In another exemplary embodiment, the present invention may comprise support for multiple interaction modes needed to respond to differing levels of immediacy and types of exchange relating to connectivity, information structures, formats and semantics. Data exchange may be between internal systems or modules, or external to a facility, and may occur in a manner that is seamless to the user. Contents of one or more clinical documents transmitted and exchanged in a variety of interchange formats may comprise: HL7 (or any other database-to-healthcare record protocol system) Messages, Clinical Document Architecture (CDA) and other HL7 Structured Documents, X12N healthcare transactions, and Digital Imaging and Communication in Medicine (DICOM) format. Using a formal explicit information model may further optimize interoperability. An example of an information model for use within the present scope of the invention may be the HL7 Reference Information Model (RIM).

In yet another exemplary embodiment, the present invention may enable the capture and management of clinical documents during direct patient care, beginning with a new encounter. Clinical document templates may be used for a typical flow of patient care through an ED encounter that starts with pre-arrival and moves through discharge. Specific clinical information may comprise, but may not be limited to, consents, assessments, care plans, orders, results, and any items said within this present invention. There are frequently times when actions/activities related to “patients” may also be applicable to the patient representative. Therefore, throughout a profile within a clinical document, the term “patient” may refer to the patient and/or the patient's personal representative, guardian, or surrogate.

In another exemplary embodiment, relating to voice data capture using the device 110, the data may be captured by standardized code sets or nomenclature, depending on the nature of the data, or may be captured as unstructured data. Data may be entered by a variety of medical personnel or caregivers. Details of who entered the data and when it was captured may be tracked by the present invention.

In certain circumstances a single patient record may be needed for legal purposes, as well as to organize information unambiguously for the provider. In one embodiment, one or more clinical documents of the present invention may be captured and may be linked to a patient record. Static data elements as well as data elements that will change over time are maintained. The patient may be uniquely identified, after which the record may be tied to that patient. It may be advantageous to the specific information directly to a patient so that if a patient returns, legacy data may be incorporated and updated when beginning a new encounter.

In accordance with an exemplary embodiment, the clinical documents created by the present invention may contain patient information including addresses and phone numbers, as well as key demographic information such as date of birth, gender, and other information and maintained for patient identification, reporting purposes and for the provision of care. Patient demographics may be captured and maintained as discrete fields (e.g., patient names and addresses) and may be enumerated, numeric or codified. Key patient identifiers may be shown on all patient information output (such as name and ID# within a patient's record). The system 100 may track the person, date, and time of when demographic information is updated according to standard guidelines.

In an exemplary embodiment, patient care should be supported and documented immediately upon arrival within an ED. In an exemplary embodiment, the present invention may provide a rapid manner of generating a new patient encounter without the need to identify the patient or previous records. The present invention may use the patient encounter transaction support facility 120, the clinical documents database 160, and/or the EDIS 170 to permit the identification of a previous patient record in the EDIS 170 to facilitate the triage process by recovering prior medications, allergies, problems, and the like. In this manner data entry may be minimized and time may be spent verifying, updating, and correcting data.

The registration process of a patient arriving at an ED, including the verification of full demographics data, insurance, contact information, etc. is frequently time consuming. To facilitate patient care in emergency situations, in an embodiment, the system of the present invention may be interoperable with other hospital systems in a time critical manner. To support interoperability with other hospital systems, for such tasks as medication or other order entry, the system may in a time critical manner, receive an account number from a hospital Admit/Discharge/Transfer (“ADT”) system, or alternatively, generate an account number in concert with the hospital IT system.

In accordance with an exemplary embodiment, the present invention may enable the capture of full demographic or financial data which may then be transferable or linked to an EDIS 170. In the EDIS environment, the EDIS 170 may be rarely used to capture full demographic or financial data. Instead, a hospital or other ADT system may be used to capture this data, which may be then transferred or linked to the EDIS 170 along with the account number generated for the visit. ADT may be automatically merged thus minimizing the administrative burden using the present invention.

In yet another exemplary embodiment, the clinical documents created using the present invention may be incorporated with external clinical data and documentation (including identification of source) such as image documents and other clinically relevant data available, and stored within the database of a computing device, which may be part of the patient encounter transaction support facility 120, the clinical documents database 160, or a database accessible to the EDIS 170. Data incorporated may be presented alongside locally captured documentation and dictations wherever appropriate. In the ED, consultants, EMS, social workers, respiratory therapists, and a number of other providers may not use the EDIS 170 to document care. Therefore, the system of the present invention may be made available to capture or link these documents or additional ancillary information to the ED visit. Data managed outside of the EDIS 170 by other providers and systems may be made accessible through the patient encounter transaction support facility 120. This data may include referral summaries, transfer summaries, DNR orders, medication lists, and the like. The data may then be linked to the patient's medical record and viewable to providers in the ED.

In still yet another exemplary embodiment, the device 110 may be interconnected among a plurality of devices. For example, in addition to communicating with patient encounter transaction support facility 120, application development environment 150, EDIS 170, etc, the device 110 may also communicate and or interconnect with other similar devices 110, cell phones, PDA's, the Internet, and any other system configured to communicate and/or receive information, data, electronic files, etc.

It should be appreciated that the device 110 may not comprise a merely passive device for recording, transmitting, receiving, etc, information and data, but may comprise a more interactive device. For example, the device 110 may actively interact with a user to provide various options and additional information as a result of the information recorded and/or received by the device 110. In one aspect, a user may collect the medical information from a patient and based upon that information, the device 110 may be configured to provide diagnosis suggestions, medication, dosage, and other care, follow up procedures, follow up questions, etc. In another aspect, based upon collected information, the device 110 may relay the information to other care givers (physicians) specialized in a particular area. For example, information collected from a child may be routed to various pediatricians for analysis, etc.

An interactive device embodiment may also comprise real-time communication, such as monitoring of a healthcare patient. For example, patient monitoring systems may communicate with the device 110 and when monitored information approaches or exceeds set parameters, the device 110 may notify a user, provide suggestions, log the data, etc. The device 110 may also conduct calculations based upon received information, and based upon the results, notify a user, provide suggestions, log the data, etc.

In accordance with an exemplary embodiment, patients themselves may provide data for voice capture using the device 110 of the present invention. The data may be distinguishable as patient-originated data. The patient-originated data may be stored and made available for use by providers. Data about the patient may then be provided to individuals including a patient, a surrogate (parent, spouse, guardian), or an informant (teacher, lawyer, case worker, etc.). Patient-originated data may also be captured by interactions with devices or electronic PHR (population health research) services and transmitted for inclusion into the electronic health record. Data entered by any of these devices may be stored with the source information. The system of the present invention may enable a provider to authenticate patient-originated data that may be included in the patient's legal health record.

In yet another exemplary embodiment, the clinical documents of the present invention may incorporate the history of the current illness and patient historical data related to previous medical diagnoses, surgeries and other procedures performed on the patient, and relevant health conditions of family members may be captured through such methods as patient reporting (for example interview, medical alert band) or electronic or non-electronic historical data. In addition, patient advance directives and provider DNR orders may be captured as well as the date and circumstances under which the directives were received, and the location of any paper records or legal documentation (e.g. the original) of advance directives as appropriate. Decisions may be documented and may include the extent of information, verification levels and exposition of treatment options, clinical and administrative consents and authorizations. A consent or authorization includes patient authorization for re-disclosure of sensitive information to third parties. Consent/authorization forms may include appropriate standardized forms for patients, guardians, foster parents, and the like. Additional forms may also include forms for adolescents according to privacy rules. It is contemplated that some states may mandate assent. Assent is an agreement by the patient to participate in services when they are legally unable to consent (e.g., an adolescent, an adult with early dementia). Clinical documents for these provisions may be converted into voice forms by the present invention.

In an exemplary embodiment, the present invention may be used for the management of information on patients who are inbound to an ED. A clinical documentation event may begin with a telephone call made from referring provider to the receiving ED. The device 110 of the present invention may be used to record the event and the data may be made available in a timely manner to the medical team. For example, knowledge of patients who are expected to arrive helps both the ED and administrative staff plan resource use in real time. Advance notification may be also be common for patients arriving via EMS. This data is most often taken during a radio call. Therefore a device 110 may also be used to capture this data with or without demographic information that may be linked to the medical record when the patient arrives. EMS arrivals frequently require in-room registration. The data captured by the device 110 may enable notification of registration of incoming ambulances and direct staff to be available as soon as the patient arrives. These capabilities may be conducted through the functions of the patient encounter transaction support facility 120. With respect to arriving patients, the present invention may enable the capture of data pertinent to the ED visit including but not limited to: mode of arrival, referral source (if any), arrival time, and the like.

In accordance with an exemplary embodiment of the present invention, the device 110 may be used to capture and document allergens, including immunizations, and substances may be identified and coded (whenever possible). The capture and documented list may be maintained over time within the clinical documents database 160. All pertinent dates, including patient-reported events, may be stored and the description of the patient allergy and adverse reaction may be modifiable over time. The entire allergy history, including reaction, for any allergen, may be retrieved for review. The list(s) may include all reactions including those that are classifiable as a true allergy, intolerance, side effect or other adverse reaction to drug, dietary or environmental triggers. Notations indicating whether an item is patient reported and/or provider verified may be maintained using the system and methods of the present invention.

In another exemplary embodiment, the present invention may enable medication lists of a patient encounter to be managed over the course of a visit or stay. All pertinent dates, including medication start, modification, and end dates may be recorded and stored within a patient's health record. The entire medication history for any medication, including alternative supplements and herbal medications may be recorded and retrievable for review. Medication lists are not limited to medication orders recorded by providers, but may include, for example, pharmacy dispense/supply records, patient-reported medications and additional information such as age specific dosage.

In yet another exemplary embodiment, the present invention may enable the capture and management of a patient problem list. The patient problem list may include, but is not limited to: chronic conditions, diagnoses, or symptoms, functional limitations, visit or stay-specific conditions, diagnoses, or symptoms. Problem lists may be managed over time, whether over the course of a visit or stay, allowing the documentation of historical information and tracking the changing character of problem(s) and their priority. The source (e.g. the provider, the system id, or the patient) of the updates may be documented and stored within the system 100. In addition all pertinent dates may be stored, including date noted or diagnosed, dates of any changes in problem specification or prioritization, and date of resolution. This may include time stamps, where useful and appropriate. The entire problem history for any problem in the list may be recorded and retrievable for review.

In accordance with another exemplary embodiment, the present invention may enable the capture and management of an immunization list of a patient. The immunization list may be managed over time whether over the course of a visit or stay. Details of immunizations administered may be captured as discrete data elements including date, type, manufacturer and lot number. The entire immunization history may be retrievable for review.

In yet another exemplary embodiment, the present invention may enable progress notes to be captured and managed to document an improvement or a decline in a patient's clinical condition over time, based upon response to therapy. Progress notes may also include unique assessments that may be standardized for a particular problem (e.g. asthma) or observation (e.g. pain).

In an exemplary embodiment, the present invention may enable the capture and management of medication orders within a clinical document. The medication orders may comprise discontinue, refill, renewal, that may require different levels and kinds of detail, as do medication orders placed in different situations. The collect details may be recorded for each situation. The present invention may allow for the administration of patient instructions to be available for selection by the ordering clinicians, or the ordering clinician may be facilitated in creating such instructions.

In yet another exemplary embodiment, the present invention may provide information of medications to be administered by a provider. The necessary information that may be presented may comprise: the list of medication orders that are to be administered; administration instructions, times or other conditions of administration; dose and route, etc. The present invention may provide verification of medications to be administered according to the unique identity of the patient. Additionally, the provider may vocally record what actually was or was not administered, and whether or not these facts conform to the order. Appropriate time stamps for all medication related activity may be generated within the system. For some settings that administer complete sets of medications from a variety of provider' orders, the present invention may provide an additional check for possible drug-drug or other interactions.

In still yet another exemplary embodiment, the present invention may enable the creation of common contents for prescription details extracted from a clinical document. The present invention may generate appropriate time stamps for all medication related activities. This may comprise a series of orders that are part of a therapeutic regimen. When a clinician places an order for a medication, that order may or may not comply with a formulary specific to the patient's location or insurance coverage, if applicable. The present invention may allow for the communication of whether the order complies with the formulary to the ordering clinician at an appropriate point to allow the ordering clinician to decide whether to continue with the order.

In accordance with an exemplary embodiment of the present invention, the present invention may enable the capture and management of non-medication orders that request actions or items. Examples may comprise orders to transfer a patient between units, to ambulate a patient, to obtain medical supplies, to procure durable medical equipment, to set up a home IV, and to execute various diet and/or therapy orders. Each item ordered may comprise the appropriate detail, such as order identification and instructions.

In an exemplary embodiment, the present invention may enable the capture and management of orders for diagnostic tests (e.g. diagnostic radiology, blood test). Each order may comprise appropriate test detail, such as order identification, instructions, and clinical information necessary to perform the test. Orders and supporting detailed documentation may be communicated to the service provider for completion of the diagnostic test(s) through the patient encounter transaction support facility 120, which in turn may be accessible to the EDIS 170.

In another exemplary embodiment, the present invention may enable the capture and management of clinical documentations relating to a referral from one care provider to another care provider. The clinical documents may comprise guidelines for whether a particular referral for a particular patient may be appropriate in a clinical context, and with regard to administrative factors such as insurance may be provided to the care provider at the time the referral is created by the present invention.

In yet another exemplary embodiment, the present invention may enable the selection and management of clinical documents containing order set templates relating to order sets, which may include medication and non-medication orders. The present invention may allow a care provider to select common orders for a particular circumstance or disease state according to standards or other criteria. The present invention may also provide for order sets templates, which may include medication orders that allow a care provider to choose common orders for a particular circumstance or disease state according to standards or other criteria. A recommended order set may be presented based on patient data or other contexts by the present invention. In addition, the present invention may provide for order entry support that comprises, but is not limited to: notification of missing results required for the order, suggested corollary orders, notification of duplicate orders, institution specific order guidelines, guideline-based orders/order sets, order sets, order reference text, patient diagnosis specific recommendations pertaining to the order. In one aspect, the present invention may provide warnings for orders that may be inappropriate or contradictory for specific patients (e.g. X-rays for pregnant women).

In accordance with an exemplary embodiment of the present invention, the present invention may enable the capture and management of results of tests. Results of tests may be presented in an easily accessible manner to the appropriate providers. The present invention may provide the capture of clinical documents and selection of clinical data that may be incorporated into flow sheets, graphs, or other tools that allow care providers to view or uncover trends in test data over time using a computing device. In addition to making results available, the results may be sent to appropriate providers using electronic messaging systems, pagers, or other communication mechanisms. The system may also allow for documentation of notification including voice documentation.

In an exemplary embodiment, the present invention may enable the capture and management of patient measures such as vital signs as discrete data to facilitate reporting and provision of care. Other clinical measures including expiratory flow rate, size of lesion, and the like may be captured and managed by the present invention.

In another exemplary embodiment, the present invention may enable the capture and management of clinical documents and notes. The specific clinical documents and notes may be unstructured and created in a narrative form, which may be based on a template, audio, and the like. The documents may also be structured documents that result in the capture of coded data.

In yet another embodiment, the present invention may enable the capture and management of all ED provider interpretations of test results. The results of diagnostic tests may or may not be interpreted by both the ED physician (e.g. ECG, plain radiography) and other physicians (e.g. radiologists or cardiologists). Similarly, the development of a differential diagnosis and process used to exclude life-threatening diagnoses may be captured for clinical documentation purposes. The present invention may also provide support for documentation which may include medico-legal and billing embodiments.

In accordance with an exemplary embodiment, the present invention may enable the capture and management of clinical documents relating to a patient scheduled test, procedure, or discharge, specific instructions about diet, clothing, transportation assistance, convalescence, follow-up with physician, etc., including the timing relative to the scheduled event. With respect to discharge, the invention may create a complete and tailored discharge package for patients discharged from the ED. The package may include instructions, prescriptions, and follow up information.

In an exemplary embodiment, the present invention may enable the facilitation of the admission process for patients being admitted to the hospital from the ED. The system may permit the clinician to enter a bed request that may comprise all the information necessary to expedite the admission, including but not limited to admitting physician, specialty or service, type of bed, and special bed needs such as isolation, private room, and the like. The present invention may coordinate the admission process by exchanging information with the EDIS 170 through the patient encounter transaction support facility 120.

In another exemplary embodiment, the present invention may enable the tracking and completion of documents after the completion of a patient encounter. After a patient encounter, a number of tasks may remain. The tasks may be outstanding laboratory tests (i.e. blood cultures), radiology interpretations, or other tasks such as arrangement of home health aids (VNA), or calls to the patient's primary care provider during office hours to establish follow-up. The present invention may provide a manner to track and document these tasks after the patient is discharged and even after clinical documentation has been finalized and signed.

In yet another exemplary embodiment, the present invention may provide prompts or alerts. The present invention may enable data entered to trigger prompts for the assessor to consider issues that would help assure a complete/accurate assessment. For example, simple demographic value or presenting problem (or combination) could provide a template for data gathering that represents best practice for a given situation, (e.g. prompt for auscultation for murmur and check BP in both arms in a patient with chest pain). When a clinician fills out an assessment, data entered may be matched against data already in the system 100 to identify potential linkages. For example, the system 100 could scan the medication list and the knowledge base to see if any of the symptoms are side effects of medication already prescribed. Important diagnoses may be brought to the doctor's attention, for instance ectopic pregnancy in a woman of child bearing age who has abdominal pain.

In still yet another exemplary embodiment, the present invention may enable the categorization of patients by triage priority. The invention may use a number of triage classification systems, and while most are not particularly complex, one classification system may be available, for example, from the EDIS 170, which may be capable of providing support to the assignment of these triage categories using evidence-base metrics. Triage may be the most fundamental process within ED care and, therefore, the categorization and prioritization of patients is of utmost importance. Unless an ED has unlimited resources, some patients will invariable need to wait. The present invention may allow for the EDIS 170 system to support the management of patients, and/or providing timely captured clinical information. This information may be displayed and patient care may be tracked using a computing device capable of displaying the clinical workflow of the ED through the EDIS 170.

In accordance with an exemplary embodiment of the present invention, the present invention may comprise a method to facilitate reducing medication errors at the time of administration of a medication. The present invention may be used to positively identity the patient; check on the drug, the dose, the route, and/or the time of administration. Clinical documentation is a by-product of this checking process; administration details and additional patient information, such as injection site, vital signs, and pain assessments, may be captured by the present invention. Workflow for medication administration may be supported through prompts and reminders regarding the “window” for timely administration of medications by the present invention.

In an embodiment, the present invention may enable the capture and management of tasks relating to patient encounters. Tasks are at all times assigned to at least one medical personnel for disposition. Whether the task may be assignable and to whom the task may be assigned may be determined by the specific needs of care setting. Task-assignment lists acquired during patient encounters may be captured to aide the medical team to prioritize specific patient care and complete assigned tasks. For example, after receiving orders on multiple patients, the RN may be provided with a list of tasks that have been assigned to him or her. These tasks, (i.e. blood draw) may then be routed to other providers in the ED (i.e. technologist). To facilitate workflow, the present invention may provide a display of required tasks, so that tasks may be routed to providers who are free and available. Task creation and assignment may be automated, where appropriate. An example of a system-triggered task may be when lab results are received electronically; a task to review the result may be automatically generated and assigned to a practitioner.

In another exemplary embodiment, the present invention may enable the reduction of potential risk of errors during the care process. A medical care provider may view and track un-disposed tasks, current work lists, the status of each task, unassigned tasks or other tasks where a risk of omission exists. The timeliness of certain tasks may be tracked, and backlogs identified. For example, the provider responsible for obtaining ECGs may be presented with a list of patients requiring an ECG. Ideally this list should be available to all providers working in the ED so that other providers are able to assist when backlogs occur.

In yet another exemplary embodiment, the present invention may enable management of patient flow by providing access to information on the patient's location during an episode of care. This function may be as simple as displaying the assigned bed for a patient (e.g. “Room 100” or “Hallway L”) by a computing device having access to the information captured by the present invention. The present invention may support real-time information about patient location as they patient receives ancillary services in other parts of a facility (e.g. “Radiology”) based on voice input from one or more clinicians during one or more patient encounters.

In still yet another exemplary embodiment, the present invention may enable the capture and management of clinical documents relating to location of patient and to record the history of the patient's movement through the ED visit. Milestones or benchmarks of ED throughput (e.g. triage time, registration time, in-room time, disposition time, and departure time) may be captured based on additional logic beyond location and room types captured by the user. Patient physical location and progress through the encounter may not necessarily be related. For example, a patient may be placed in a hallway chair instead of a room. However the present invention may accommodate this situation. For example, this placement may be recorded as the time the patient entered the treatment area (a.k.a. “In Room Time”).

In accordance with an exemplary embodiment of the present invention, the present invention may enable hardcopy and electronic output of clinical documents relating to patient encounters. The present invention may fully chronicle the healthcare process and provide support for the selection of specific sections of the health record. The present invention may also allow healthcare organizations to define the report and/or documents that may comprise the formal health record for disclosure purposes. The present invention may allow for both chronological and specified record element output. This may include defined reporting groups (e.g. print sets).

In an exemplary embodiment, the present invention may enable the capture and management of clinical documents relating to administrative and financial purposes of a patient health record including reimbursement. The information may be captured and transmitted to administrative or financial processes as a by-product of interactions such as order entry, result entry, documentation entry, and/or medication administration charting. As a by-product of care delivery and documentation, relevant clinical data may be captured to support coding. The system 100 may perform coding based on documentation. Clinical information needed for billing may also be made available on the date of service, reducing revenue cycle time.

In another exemplary embodiment, the present invention may provide for authentication. The present invention may provide mechanisms for users and any applications to be authenticated. In general, users may be authenticated when they attempt to use the application. The applications, including database applications, may also authenticate themselves before accessing EHR information managed by other applications or remote EHR. In order for authentication to be established a Chain of Trust agreement may need to be in place. Examples of entity authentication may comprise: usernames/passwords, digital certificates, secure tokens, biometrics, and the like.

In yet another exemplary embodiment, the present invention may enable capture and management of attestation within a clinical document. Attestation may be used to show authorship and assign responsibility for an act, event, condition, opinion, or diagnosis associated with a patient encounter. Every entry in the clinical document may be identified with the author and should not be made or signed by someone other than the author. Attestation may be required for (paper or electronic) entries such as narrative or progress notes, assessments, flow sheets, and orders. Digital signatures may also be used to implement document attestation.

In still yet another exemplary embodiment, the present invention may enable an authorized user, such as a clinician, to access and aggregate the distributed information within the patient encounter transaction support facility 120 or the EDIS 170, which corresponds to the health record or records that are needed for viewing, reporting, disclosure, and the like. The present invention may support data extraction operations across a complete data set that constitutes the health record of an individual containing one or more clinical documents and may provide an output that fully chronicles the healthcare process. The data extractions may be used as input to patient care coordination between facilities, organizations and settings. In addition, data extractions may be used for administrative, financial, research, quality analysis, and public health purposes.

In the foregoing specification, the invention has been described with reference to numerous specific exemplary embodiments and applications; however, various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to any specific order presented in the claims. Additionally, the components and/or elements recited in any apparatus or system claims may be assembled or otherwise operationally configured in a variety of permutations to produce substantially the same result as the present invention and are accordingly not limited to the specific configuration recited in the claims.

Benefits, other advantages and solutions to problems have been described above with regard to particular exemplary embodiments; however, any benefit, advantage, solution to problem or any element that may cause any particular benefit, advantage or solution to occur or to become more pronounced are not to be construed as critical, required, or essential features or components of any or all the claims.

As used herein, the terms “comprise”, “may comprise”, “comprising”, “having”, “including”, “includes” or any variation thereof, are intended to reference a non-exclusive inclusion, such that a process, method, article, composition, system, or apparatus that may comprise a list or elements does not include only those elements recited, but may also include other elements not expressly listed or inherent to such process, method, article, composition, system, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters or other operating requirements without departing from the general principles of the same.

What is claimed is:

1. A system for managing a clinical document for a healthcare patient comprising:
a device wherein,
the device receives voice command input and the voice command input comprises at least one data element for the clinical document;
a clinical documents database wherein,
the clinical documents database stores the at least one data element from the device and provides stored data to the device;
a patient encounter transaction support facility wherein,
the patient encounter transaction support facility provides at least software support for the device; and
a communication network wherein,
the communication network provides inter-connectivity to exchange information among the device, the clinical documents database, and the patient encounter transaction support facility.

2. The system of claim 1, further comprising an application development environment to manage at least the clinical document, and the application development environment further couples to the communication network.

3. The system of claim 2, further comprising at least an emergency department information service to provide at least emergency department information to the communication network.

4. The system of claim 3, wherein the communication network comprises a wireless communication network.

5. The system of claim 4, wherein the device is a remote hand held device.

6. The system of claim 1, wherein the at least one data element comprises data for the clinical document during direct patient care.

7. The system of claim 1, wherein the at least one data element comprises demographic information of the healthcare patient.

8. The system of claim 1, wherein the device interoperates with other hospital communication systems and electronic medical records.

9. The system of claim 1, wherein the at least one data element comprises financial information of the healthcare patient.

10. The system of claim 1, wherein the at least one data element comprises insurance information of the healthcare patient.

11. The system of claim 1, wherein the clinical document incorporates with external clinical data and documentation.

12. The system of claim 1, wherein the at least one data element comprises at least one of history and physical assessment of a current illness of the healthcare patient.

13. The system of claim 1, wherein the at least one data element comprises historical data of the healthcare patient related to at least one of: a previous medical diagnoses, a surgery, and relevant health conditions of family members.

14. The system of claim 1, wherein the at least one data element comprises a medication list of a healthcare patient to be managed over a course of a hospital visit or a hospital stay.

15. The system of claim 1, wherein the at least one data element comprises an immunization list of the healthcare patient.

16. The system of claim 1, wherein the at least one data element comprises progress notes of the healthcare patient to document an improvement or a decline in a clinical condition over time based upon response of a therapy of the healthcare patient.

17. The system of claim 1, wherein the at least one data element comprises a medication order.

18. The system of claim 1, wherein the at least one data element comprises a medication to be administered by a provider.

19. The system of claim 1, wherein the at least one data element comprises a time stamp for all medication related activities.

20. The system of claim 1, wherein the at least one data elements comprises an order for a diagnostic test.

21. The system of claim 1, wherein the at least one data element comprises a referral from one care provider to another care provider.

22. The system of claim 1, wherein the device provides warnings for an inappropriate or contradictory order specific to the healthcare patient.

23. The system of claim 1, wherein the at least one data element comprises a test result.

24. The system of claim 1, wherein the at least one data element related to a discharge of the healthcare patient comprises at least one of: a scheduled test, a procedure, a specific instruction about diet, transportation assistance, convalescence, and a physician follow-up.

25. The system of claim 1, wherein the device provides a prompt or an alert.

26. The system of claim 1, wherein the device enables categorization of patients in an emergency department by triage priority.

27. The system of claim 1, wherein the device provides at least one of a hardcopy output and an electronic output of the clinical document.

28. The system of claim 1, wherein the device comprises a user authentication application.

29. The system of claim 1, wherein the at least one data element comprises attestation within the clinical document.

30. A method for managing a clinical document for a healthcare patient comprising:
providing a device wherein,
the device receives voice command input and the voice command input comprises at least one data element for the clinical document;
providing a clinical documents database wherein,
the clinical documents database stores the at least one data element from the device and provides stored data to the device,
providing a patient encounter transaction support facility wherein,
the patient encounter transaction support facility provides at least software support for the device; and
providing communication network wherein,
the communication network provides inter-connectivity to exchange information among the device, the clinical documents database, and the patient encounter transaction support facility.

31. The method of claim 30, further comprising providing an application development environment to manage at least the clinical document, and the application development environment further couples to the communication network.

32. The method of claim 31, further comprising providing at least one of an emergency department information service to provide at least emergency department information to the communication network.

33. The method of claim 32, wherein providing the communication network comprises providing a wireless communication network.

34. The method of claim 33, wherein providing the device comprises providing the device to be a remote hand held device.

35. The method of claim 30, wherein the at least one data element comprises data for the clinical document during direct patient care.

36. The method of claim 30, wherein the at least one data element comprises demographic information of the healthcare patient.

37. The method of claim 30, wherein the device interoperates with other hospital communication systems.

38. The method of claim 30, wherein the at least one data element comprises financial information of the healthcare patient.

39. The method of claim 30, wherein the at least one data element comprises insurance information of the healthcare patient.

40. The method of claim 30, wherein the clinical document incorporates with external clinical data and documentation.

41. The method of claim 30, wherein the at least one data element comprises at least one of a history and a physical assessment of a current illness of the healthcare patient.

42. The method of claim 30, wherein the at least one data element comprises historical data of the healthcare patient related to at least one of: a previous medical diagnoses, a surgery, and relevant health conditions of family members.

43. The method of claim 30, wherein the at least one data element comprises a medication list of a healthcare patient to be managed over a course of a hospital visit or a hospital stay.

44. The method of claim 30, wherein the at least one data element comprises an immunization list of the healthcare patient.

45. The method of claim 30, wherein the at least one data element comprises progress notes of the healthcare patient to document an improvement or a decline in a clinical condition over time based upon response of a therapy of the healthcare patient.

46. The method of claim 30, wherein the at least one data element comprises a medication order.

47. The method of claim 30, wherein the at least one data element comprises a medication to be administered by a provider.

48. The method of claim 30, wherein the at least one data element comprises a time stamp for all medication related activities.

49. The method of claim 30, wherein the at least one data elements comprises an order for a diagnostic test.

50. The method of claim 30, wherein the at least one data element comprises a referral from one care provider to another care provider.

51. The method of claim 30, wherein providing the device comprises providing the device to provide warnings for an inappropriate or contradictory order specific to the healthcare patient.

52. The method of claim 30, wherein the at least one data element comprises a test result.

53. The method of claim 30, wherein the at least one data element related to a discharge of the healthcare patient comprises at least one of: a scheduled test, a procedure, a specific instruction about diet, transportation assistance, convalescence, and a physician follow-up.

54. The method of claim 30, wherein providing the device comprises providing the device to provide a prompt or an alert.

55. The method of claim 30, wherein providing the device comprises providing the device to enable categorization of patients in an emergency department by triage priority.

56. The method of claim 30, wherein providing the device comprises providing the device to provide at least one of a hardcopy output and an electronic output of the clinical document.

57. The method of claim 30, wherein providing the device comprises providing the device to comprises a user authentication application.

58. The method of claim 30, wherein the at least one data element comprises attestation within the clinical document.

59. A method for generating a clinical document comprising:
providing a user with a visual representation of at least a portion of the clinical document via a visual display device;
audibly prompting the user to provide at least one data element for the clinical document;
receiving a vocal response from the user;
converting the vocal response to corresponding textual data;
providing the user with an updated visual representation of the clinical document via the visual display device; and at least one of generating a printed clinical document corresponding to the updated visual representation of the document; storing at least a portion of the clinical document; storing the clinical document as a clinical document template; and storing the clinical document as a modified clinical document template.
